(19) United States
(12) Patent Application Publication
(10) Pub. No.: US 2006/0184509 A1
(43) Pub. Date: Aug. 17, 2006

(54) Database arrangement

(76) Inventor: Saeema Ahmed, Cambridge (GB)

Correspondence Address: NIXON & VANDERHYE, PC, 901 NORTH GLEBE ROAD, 11TH FLOOR, ARLINGTON, VA, 22203, US

(21) Appl. No.: 10/544,538

(22) PCT Filed: Jan. 20, 2004
(86) PCT No.: PCT/GB04/00201

§ 371 Date: Aug. 5, 2005

(30) Foreign Application Priority Data
Feb. 6, 2003 (GB) 0302640.8

(51) Int. Cl. G06F 17/30

(52) U.S. Cl. 707/3

(57) ABSTRACT

A database contains data items with which various index terms 40 are associated. The database arrangement maintains information about relationships between the index terms, there being a relationship between any two index terms which are both associated with a data item in common. This allows a user to be provided with a graphical representation (see drawing) of the relationship between index terms. When index terms are used to interrogate the database, the user is provided with a graphical display of that part 50 of the network relationships which includes the requested index term (e.g. Product 1) and all other index terms with which that terms has a relationship. This assists a user in refining a search strategy and thus improves the quality of information retrieval from the database.

The present invention relates to database arrangements.

In many fields of research, such as engineering design within a large industrial organisation, a large amount of knowledge is generated when a product or component is designed. Some of this information is potentially valuable to others within the organisation. For example, they may be able to learn from the design process applied to one product, to improve the design process being applied to a subsequent product, or they may be able to obtain solutions to problems encountered in designing the subsequent product. The full value of the knowledge being generated cannot be realised by the organisation unless it is captured in a way which allows it to be retrieved when required.

A common approach to assist in knowledge retrieval is to index the knowledge according to a classification structure. This can lead to difficulty for users in retrieving relevant information unless the user has detailed knowledge of the classification structure. This requirement acts as a disincentive to users, particularly occasional users.

In accordance with the present invention, there is provided a database arrangement for use with data items having one or more index terms associated therewith, comprising:

relationship storage means operable to store relationship information relating to the index terms associated with the data items in the database;

identifying means operable to identify the or each index term contained in a user request for interrogating the database;

consulting means operable to consult the relationship information to identify other index terms which are associated with data items with which the index term or terms of the request are associated; and

information means operable to provide information relating to the index terms or terms of the request and the other index terms, for presentation to the user.

The information means may provide information for presentation to a user in graphical form. Preferably, the information is provided as a diagram of index terms, the diagram showing a link between combinations of index terms which are associated with data items in common. Preferably the links are provided to display weighting information representing the frequency of occurrence of at least some combinations. The frequency may be the frequency of data items occurring in the database. Alternatively, the frequency may be the frequency of new data items being added to the database.

The arrangement may be operable to receive requests from a user at a remote location. The arrangement may be in communication with the user by means of a communication network, which may be a public or private network.

The arrangement preferably also comprises index means operable to identify the or each index term associated with a data item contained in or to be added to the database, and modifying means operable to modify the relationship information in accordance with identified index terms. The modifying means may modify the relationship information to record combinations of index terms which are associated with data items in common. The modifying means may cause the relationship information to contain weighting information relating to at least some combinations, weightings being chosen according to a frequency of occurrence. The frequency may be the frequency of occurrence of data items in the database, or the frequency of occurrence in new data items to be added to the database.

The database arrangement may be in communication with a database holding the data items, by means of a communication network, such as a public or private network.

The invention also provides a signal propagating on a transmission medium, the signal representing information provided by information means of a database arrangement as set out above, the information relating to the index term or terms of a request, and the other index terms, for presentation to a user.

In a second aspect, the invention provides a database arrangement for use with data items having one or more index terms associated therewith, comprising:

relationship storage means operable to store relationship information relating to the index terms associated with the data items in the database; and

index means operable to identify the or each index term associated with a data item contained in or to be added to the database, the arrangement further comprising modifying means operable to modify the relationship information in accordance with the identified index terms.

The modifying means may modify the relationship information to record combinations of index terms which are associated with data items in common. The modifying means may cause the relationship information to contain weighting information relating to at least some combinations, weighting being chosen according to a frequency of occurrence, such as the frequency of occurrence in data items in the data base, or the frequency of occurrence in new data items to be added to the database.

The database arrangement is preferably in communication with a database holding the data items, by means of a communication network, such as a public or private network.

The information means may provide information for presentation to a user in graphical form. Preferably, the information is provided as a diagram of index terms, the diagram showing a link between combinations of index terms which are associated with data items in common. Preferably the links are provided to display weighting information representing the frequency of occurrence of at least some combinations. The frequency may be the frequency of data items occurring in the database. Alternatively, the frequency may be the frequency of new data items being added to the database.

The arrangement may be operable to receive requests from a user at a remote location. The arrangement may be in communication with the user by means of a communication network, which may be a public or private network.

In a further aspect, the invention provides a database arrangement for use with data items having one or more index terms associated therewith, comprising:

relationship storage means operable to store relationship information relating to the index terms associated with the data items in the database;

index means operable to identify the or each index term associated with a data item contained in or to be added to the database;

modifying means operable to modify the relationship information in accordance with the identified index terms;

identifying means operable to identify the or each index term contained in a user request for interrogating the database;

consulting means operable to consult the relationship information to identify other index terms which are associated with data items with which the index term or terms of the request are associated; and

information means operable to provide information relating to the index term or terms of the request and the other index terms, for presentation to the user.

Preferably the database arrangement further includes a database containing the data items.

In a further aspect, the invention provides computer software which, when installed on a computer system, is operable to provide a database arrangement as set out above. The invention also provides a carrier medium carrying computer software as aforesaid.

In accordance with a further aspect, the invention provides a method of providing a database for data items having one or more index terms associated therewith, in which:

relationship information is stored, relating to the index terms associated with the data items in the database;

the or each index term contained in a user request for interrogating the database is identified;

the relationship information is consulted to identify other index terms which are associated with data items with which the index term or terms of the request are associated; and

information relating to the index term or terms of the request and the other index terms is provided for presentation to the user.

The information may be provided for presentation to a user in graphical form. Preferably, the information is provided as a diagram of index terms, the diagram showing a link between combinations of index terms which are associated with common data items.

Preferably the links are provided to display weighting information representing the frequency of occurrence of at least some combinations. The frequency may be the frequency of data items occurring in the database. Alternatively, the frequency may be the frequency of new data items being added to the database.

Requests from a user may be received at a remote location. Communication with the user may be by means of a communication network, which may be a public or private network.

The or each index term associated with a data item contained in or to be added to the database is preferably identified, and the relationship information is modified in accordance with the identified index terms. Combinations of index terms which are associated with data items in common may be recorded. The relationship information may contain weighting information relating to at least some combinations, weightings being chosen according to a frequency of occurrence. The frequency may be the frequency of occurrence of data items in the database, or the frequency of occurrence of new data items to be added to the database.

In a further aspect, the invention provides a method of providing a database for data items having one or more index terms associated therewith, in which:

relationship information relating to the index terms associated with the data items is stored in the database;

the or each index term associated with a data item contained in or to be added to the database is identified; and

the relationship information is modified in accordance with the identified index terms.

The relationship information may be modified to record combinations of index terms which are associated with data items in common. The relationship information may contain weighting information relating to at least some combinations, weighting being chosen according to a frequency of occurrence, such as the frequency of occurrence in data items in the database, or the frequency of occurrence in new data items to be added to the database.

Information may be provided for presentation to a user in graphical form. The information may be provided as a diagram of index terms, the diagram showing a link between combinations of index terms which are associated with data items in common. Preferably the links are provided to display weighting information representing the frequency of occurrence of at least some combinations. The frequency may be the frequency of data items occurring in the database. Alternatively, the frequency may be the frequency of new data items being added to the database.

Requests from a user may be received at a remote location. Communication with the user may be by means of a communication network, which may be a public or private network.

In a further aspect, the invention provides a method of providing a database for data items having one or more index terms associated therewith, in which:

relationship information relating to the index terms associated with the data items in the database is stored;

the or each index term associated with a data item contained in or to be added to the database is identified;

the relationship information is modified in accordance with the identified index terms;

the or each index term contained in a user request for interrogating the database is identified;

the relationship information is consulted to identify other index terms which are associated with date items with which the index term or terms of the request are associated; and

information relating to the index term or terms of the request and the other index terms is provided, for presentation to a user.

Examples of arrangements in accordance with the present invention will now be described in more detail, by way of example only, and with reference to the accompanying drawings, in which:

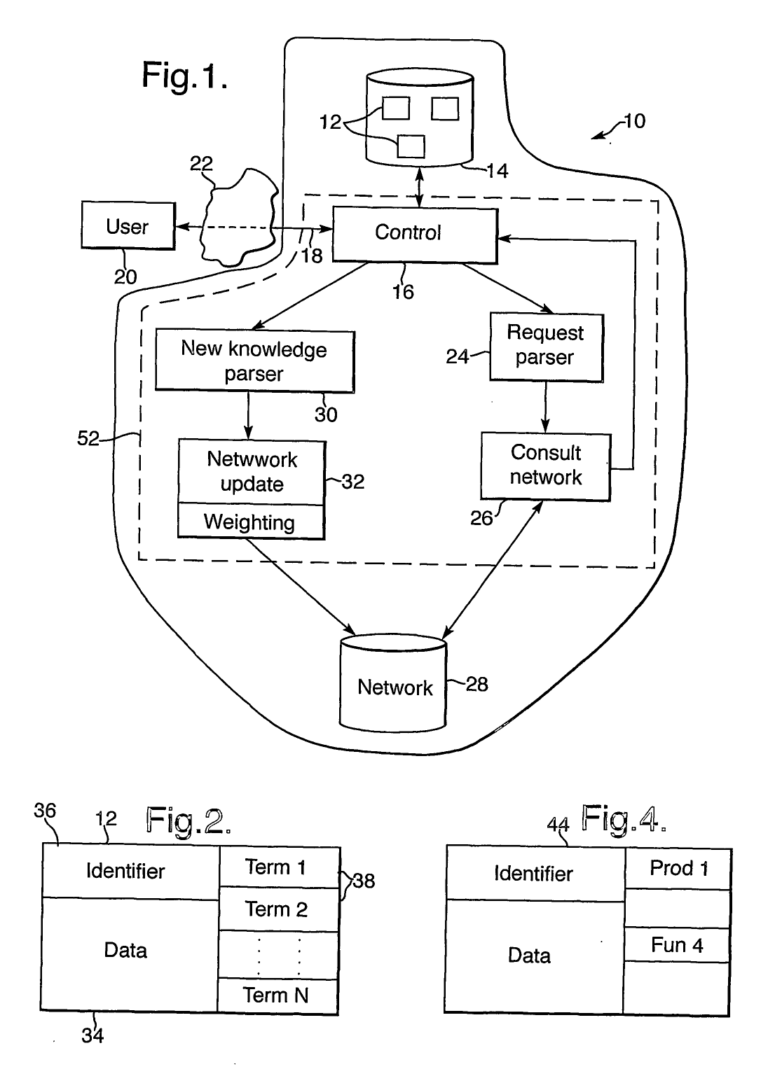

FIG. 1 is a schematic diagram of a database arrangement in accordance with the present invention;

FIG. 2 is a diagrammatic representation of a database item within a database with which the arrangement of FIG. 1 is in use;

FIG. 3 represents relationship information maintained within the arrangement of FIG. 1;

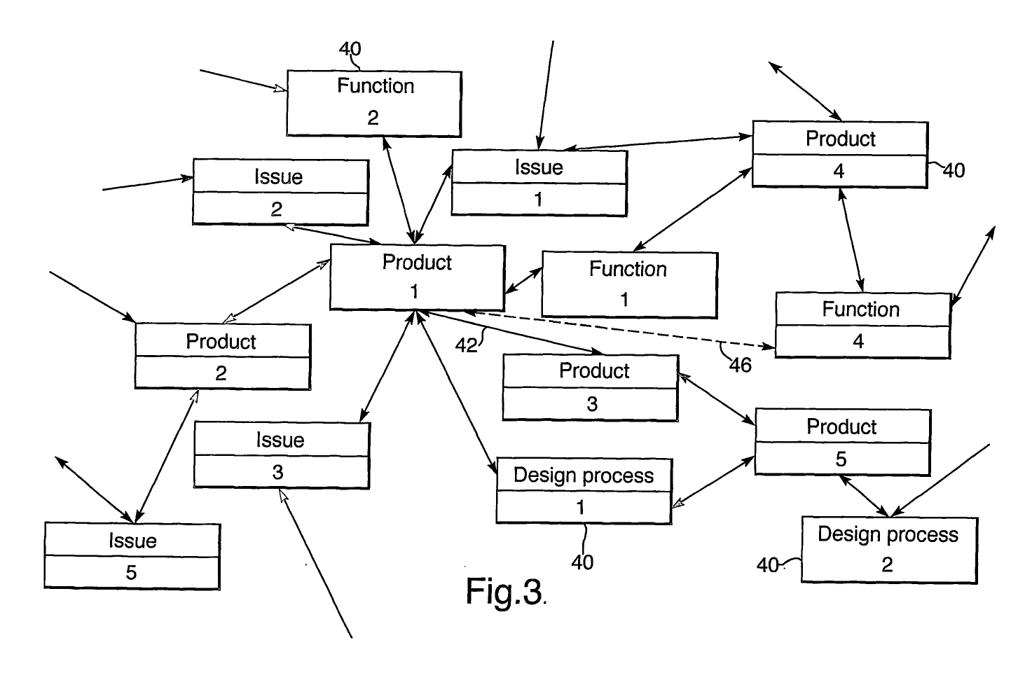

FIG. 4 represents a particular new data item to be introduced into the database;

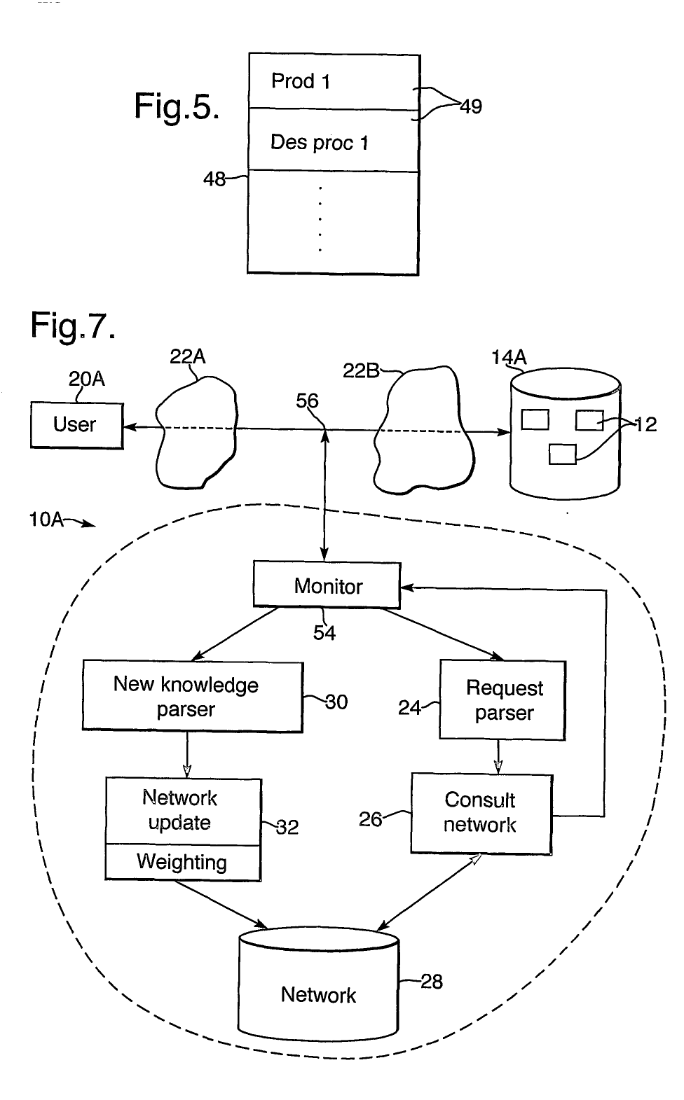

FIG. 5 schematically represents a user request for interrogating the database;

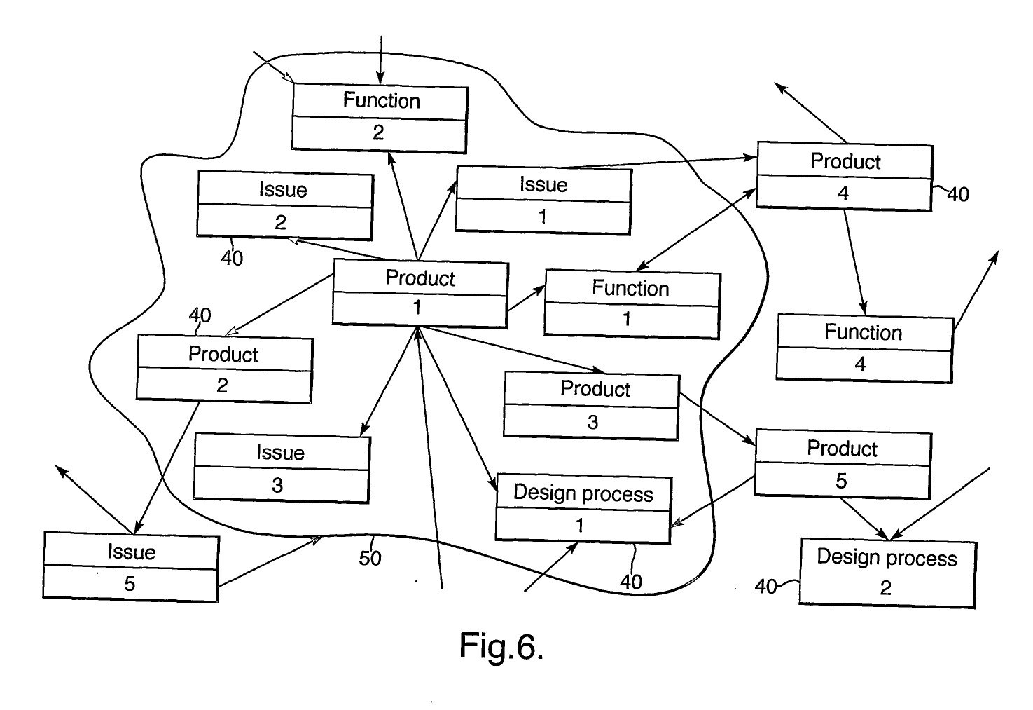

FIG. 6 represents a graphical form of information provided to a user in response to a request, by the arrangement of FIG. 1;

FIG. 7 corresponds with FIG. 1, showing an alternative implementation; and

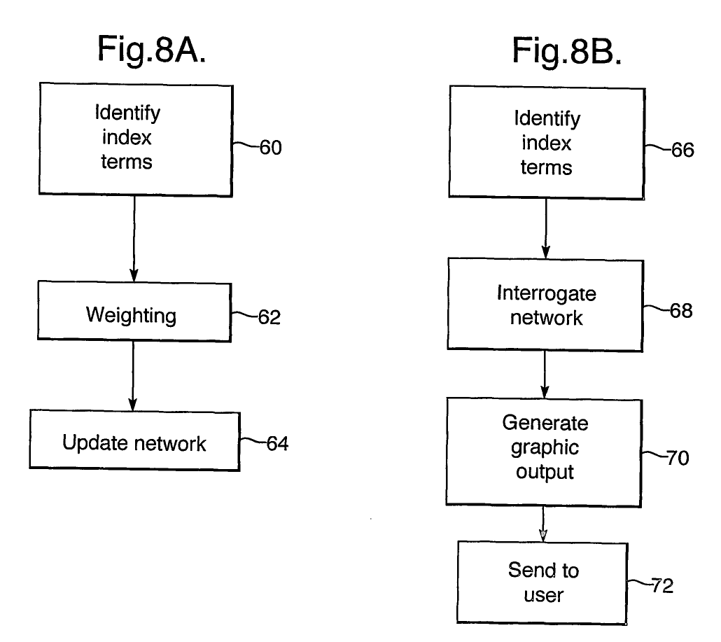

FIGS. 8A and 8B are simple flow diagrams relating to operation of the arrangements to be described.

### OVERVIEW

FIG. 1 illustrates a database arrangement 10 for use with data items 12 stored in a database 14. Each data item 12 has one or more index terms associated with it, as will be described. Retrieval of data items 12 from the database 14 is controlled by operation of a control module 16 upon receipt of user requests at 18 from a user 20. The user 20 may be operating a computer or other device, and the connection 18 may be direct, or by means of a public or private network indicated at 22. User requests will specify one or more index terms of interest to the user, as will be described. This allows the control module 16 to retrieve all data items with which the index term or terms selected by the user are associated.

The arrangement also includes a request parser in communication with the control module 16. When the control module 16 receives a user request, the control module 16 will, in addition to retrieving data items 12, pass the request to the parser 24. Parsing by the parser 24 allows the or each index term contained in the user request to be identified. The identified index terms are passed to a consulting module 26 which is able to consult the contents of a second database 28, containing relationship information which will be described in more detail below. The consulting module 26 uses the contents of the database 28 to identify other index terms (in addition to those retrieved by the parser 24) which are associated with data items 12 with which the index term or terms of the request (i.e. retrieved by the parser) are associated. Information relating to the request index terms and the other index terms is passed to the control module 16, which provides information for presentation to a user and relating to all of these index terms, as will be described.

The contents of the database 28 are created by operation of a second parser 30 (illustrated in FIG. 1 as a “new knowledge parser”) and an updating module 32. The parser 30 identifies the or each index term associated with a data item 12 contained in or to be added to the database 14. In response to this, the updating module 32 is able to modify the relationship information contained in the database 28.

Data Item

Before describing the operation of the arrangements in more detail, it is appropriate to describe the form of a data item, as shown in FIG. 2. FIG. 2 in intended purely as a schematic representation to assist in a full comprehension of the nature of the invention.

The data item 12 is in the form of a file of information including the data itself, at 34, and other information. The data 34 may be of many types, such as a file containing a document, drawing, e.mail, for example. The other information includes an identifier 36, which uniquely labels the data item 12 to allow for indexing and retrieval from the database 14. The data 34 also has one or more index terms 38 associated with it the index terms are preferably selected from a classification system. The classification system may contain groups of terms. For example, in an engineering design environment, there may be four groups of terms available for indexing, relating to (a) the type of product to which the data 34 is relevant, (b) design issues considered within the data 34 or to which the data 34 is relevant, such as weight, cost, manufacturability etc., (c) function information to which the data 34 is relevant, and (d) design process information, such as the stage of the design process to which the data 34 relates. For example, the data 34 might relate to the design of a turbine blade, so that the term “weight” is selected from the second group. The term “turning air” may be selected from the third group, relating to the function of a turbine blade. A term from the fourth group may identify that the data 34 is relevant to the conceptual design stage of the turbine blade.

Many difference classifications could be used, according to the proposed use of the database 14. The choice of these four groups has been found appropriate from observation of the style of language used by engineers. Other groups or numbers of groups could alternatively be chosen. Terms within groups can be chosen as appropriate, as can the nature and number of the groups. In some circumstances, the use of groups might not be appropriate, so that all terms would be contained within a single group. Multiple index terms can be chosen from within a single group or groups to be associated with the data 34.

It is important to note, for a fuller understanding of the description below, that the list of available index terms is not required to be fixed, but can evolve over time, as further information is added to the database.

Relationship Network

It is apparent from the foregoing description of FIG. 2 that several index terms may be associated with a single piece of data 34. Thus, in the example just set out, the index terms “turbine blade”, “weight”, “turning air” and “conceptual design stage” all have associated data in common. This association with a common data item is used, in accordance with the present invention, to indicate a relationship between these index terms. Two index terms are related if there exists at least one data item with which both index terms are associated. Thus, it is assumed that if one data item has this selection of index terms associated with it, other data items already in existence or to be added later to the database 14, will also have these combinations of index terms associated. Similarly, users are likely to require information relating to these combinations. For example, the weight of a turbine blade is likely to be relevant to any turbine blade design project and consequently, a designer is likely to interrogate the database 14 to seek other data items 12 which relate to turbine blades and weight.

The database 28 stores information relating to these relationships, i.e. to all combinations of index terms which arise from all of the data items 12 stored in the database 14, or subsequently added to it. These relationships are maintained in the form of a network of links between the index terms. Part of a network is illustrated schematically in FIG. 3. FIG. 3 shows various blocks 40 which each represents a single index term identified (in this drawing) by the group to which the term belongs (“design process”, “product”, “function” of “issue”) and an identifying number identifying the term from that group. Arrows are shown in FIG. 3, interconnecting various blocks 40. An arrow is provided between blocks, if there is a data item 12 within the database 14 and to which that pair of index terms are both associated. Thus, an arrow 42 indicates a relationship between the index terms Product 1 and Product 3. This indicates that there is at least one data item 12 in the database 14 and to which the index terms Product 1 and Product 3 have both been associated. For example, Product 1 might be the term “turbine blade”, and Product 3 might be the term “compressor blade”. Since some aspects of the design of turbine blades are common to the process of designing compressor blades, data items relating to this subject matter may have both index terms associated and are likely to be relevant to future designers of either product.

It will be readily apparent to those skilled in the art that a network of relationships of the type just described will, in practice, become extremely complex and large in a real situation with large numbers of index terms available for data items. For this reason, the relationship information within the database 28 may be stored in various forms, according to the complexity or expected complexity of the relationships. This information may be stored as a table of index terms, indicating the other index terms to which there is a relationship. From this, a graphic representation equivalent to FIG. 3 can, in principle, be constructed for the entire set of available index terms.

Updating the Relationship Network

The relationship network of FIG. 3 is initially created by analysing the contents of the database 14 when the database is first set up. Thereafter, each time a new data item 12 is added to the database 14, the relationship network of FIG. 3 may require updating.

FIG. 4 illustrates a new data item 44. This has the index terms Product 1 (PROD 1) and Function 4 (FUN 4) associated with it. When the item 44 is received for entering into the database 14, the control module 16 passes the item 44 (or the part representing the index terms) to the new knowledge parser 30, which operates to identify the index terms, i.e. Product 1 and Function 4. Having identified these terms, they are passed to the updating module 32. By consulting the contents of the database 28, the updating module 32 can identify that no relationship has yet been recorded between the index terms Product 1 and Function 4. The contents of the database are therefore updated to represent the additional of a notional further arrow between those blocks 40 which represent Product 1 and Function 4. This new relationship is identified in FIG. 3 as a broken arrow 46.

User Enquiry

A user enquiry for interrogating the database 14 will be received by the control module 16 in a form shown schematically at 48 in FIG. 5 and containing one or more index terms (49) from which the user requires relevant data items 12 to be identified. This operation is achieved by the control module 16, which identifies and retrieves all data items 12 which match the enquiry profile identified in the user request.

In addition, the enquiry is passed to the request parser 24 which applies a parsing technique to the enquiry to retrieve the individual index terms from the request. Alternatively, this parsing may be undertaken within the control module 16 as part of preparation for interrogation of the database 14 by the control module 16.

The index terms identified from the request are then passed to the consulting module 26. The consulting module 26 interrogates the database 28 to select and retrieve information about that part of the relationship network which relates to the index terms retrieved from the request, including relationships between those index terms and any other index terms with which the terms of the request are related. Thus, the relevant part of the relationship network is identified by taking an index term from the request, locating this on the relationship network, identifying all other index terms with which a relationship is indicated by the relationship network, and then proceeding in the same manner with each other index term retrieved from the user request.

By virtue of the manner in which relationships are created and recorded, as described above, this has the effect of identifying other index terms which are also associated with data items with which the index term or terms of the request are associated.

Thus, by considering the first index term (Product 1) of the request in FIG. 5, a region of the relationship network of FIG. 3 can readily be identified as including the index term Product 1, and all other index terms with which the index term Product 1 has a relationship. Fig shows the network of FIG. 3, with the boundary 50 of the region identified from the first index term. The selection of the region 50 (as shown on FIG. 6) assumes that the data item giving rise to the relationship 46 (FIG. 3) has not yet been analysed.

After identifying the area 50, this process can be repeated by the consulting module 26, based on the next index term (Design Process 1) from the enquiry 48. This allows the selection of the region 50 to change and evolve as further index terms are analysed.

After this process has been repeated for every index term within the request 48, the consulting module 26 reports the final selection of the region 50 to the control module 16. The control module 16 incorporates this information in the reply supplied to the user, which includes details, or the whole content, of every data item 12 which meets the request criteria, and also provides the user with the relationship information recovered by the consulting module 26.

User Results

The results passed back to the user will, as just described, include the results of the interrogation of the database 14, and also the results of the work of the consulting module 26. Information about the results of the consulting module 26 are preferably provided in a manner which allows the user to be presented with a graphical representation of the relevant part of the relationship network identified by the module 26. For example, in the event that the user request included only the index term Product 1, the user would be provided with a graphic display of the area 50. This provides relationship information to the user in a form which is readily assimilated and can prompt the user to think about other issues or other possible index terms. For example, in the example just described, the index term Product 1 has been used, but the user will see from the relationship information within the area 50 that there is a relationship between Product 1 (a turbine blade in the example discussed above) and Product 3 (a compressor blade in the example discussed above). If the user had overlooked the fact that information relating to Product 3 may also be relevant to Product 1, or was not aware of this, the link displayed in the relationship network will draw the user's attention to this, and the user is then able to make a further request, or modify the existing request, in order to retrieve further data items based on an enquiry using the index term Product 3.

The result is an interface which readily prompts the user to consider other possible forms of request, presenting those alternative possibilities after selecting only those likely to be of relevance, by virtue of the relationships established within the relationship network.

Weighting of Relationship Information

The updating module 32 may introduce an additional relationship into relationship network on each occasion that a new combination of index terms is found in a data item 12. In practice, it is expected that this may result in an extremely complex network of relationships, including some which are more significant than others, but apparently equivalent when presented to a user. Thus, the arrangement can be further improved by providing a form of weighting to the relationships recorded within the relationship network. For example, the updating module 32 may monitor the frequency with which particular relationships arise from data items 12, and the database 28 may record this information so that it can be presented to the user, for example by presenting links between blocks 40 in a manner which indicates the weighting. This may be by changing colour, boldness of presentation, style or otherwise. Relationships which fall below a minimum weighting may be removed from the relationship network, as being unlikely to be of future interest, and possibly causing confusion to users.

Weighting can be judged in various ways, such as frequency of occurrence of a relationship within the data items 12, or the frequency with which the relationship is found within new items being added to the database 14 over a chosen period of time.

Directional Relationships

Some relationships between index terms may be meaningful or helpful in one direction, but not in the other. For example, a particular product may be made by a particular process, so that a relationship pointing to the process from the product may be helpful to the user. However, the process may be a common one, used for making a wide range of products, some of which are unlikely to be of interest. Thus, relationships from products to that process may be single directional, so that a request which uses a particular product as an index term will recover relationship information relating to the process, but not all those other products which also have links to the same process, some of which are likely to be irrelevant. Directional relationships can be graphically represented by single headed arrows.

When index terms are formed into groups, rules may be implemented to inhibit relationship in particular directions, according to group memberships of index terms.

Implementation of FIG. 1

The arrangement of FIG. 1 can be implemented in many arrangements of hardware, software and combinations. For example, the modules within the broken line 52 may be implemented as appropriate hardware or software modules, such as software modules running on an appropriately programmed general purpose computer connected to communication with the databases 14, 18 and the user 20.

Alternative Arrangements

FIG. 7 illustrates an alternative arrangement to the arrangement of FIG. 1. In FIG. 7, the database arrangement 10A is remote from the user 20 (as described above) and is also remote from the database 14. For example, the arrangement 10A may be in communication with the user 20A over a network 22B, which may be the same as the network 22A, or a different network.

In this arrangement, the functions of the control module 16 of FIG. 1 are divided between a conventional control module (not shown) and a monitor module 54. The conventional module is within the database 14A, to respond to requests and use index terms to retrieve data items 12 for return to a user 20A. Other functions, relating to the invention, are performed by the monitor module 54 (FIG. 7). The monitor module monitors traffic at 56, passing between the user 10A and the database 14A, to identify requests being sent to the database 14A. These requests are then passed to the request parser 24, for relationship network information to be retrieved in the manner described above and passed to the monitor module 54 for forwarding to the user 20A either directly, or via the database 14A. The monitor module 54 is also able to interrogate the database 14A for information (particularly information about index terms) about data items within the database 14A or newly added to it. This information is passed to the new knowledge parser 30 for use in updating the relationship network, as described above.

Summary of Methods Employed

FIGS. 8A and 8B may be used to summarise briefly the methods implemented within the arrangements described above.

FIG. 8A represents the process of updating the relationship network information. Index terms in new data items are identified at 60 to establish the relationships they represent. These relationships are optionally provided with a weighting at 62 and then used to update the relationship network information at 64.

FIG. 8B illustrates a method of responding to a user request. Index terms included in the request are identified at 66. The database 28 is interrogated at 68 to retrieve the relevant part of the relationship network from which a graphical representation is created at 70 and sent to the user at 72.

Concluding Remarks

It will be readily apparent from the above description that very many modifications can be made to the apparatus and software with which the techniques of the present invention are implemented. These possible variations include choices of hardware and hardware technologies, software and programming languages.

It will also be apparent that the arrangements can be incorporated within a complete database system which contains the database of data items and also provides the functions of maintaining and reporting from the relationship network. Alternatively, the functions relating to the relationship network could be provided in a separate arrangement which is in communication with the user and the database by any convenient means, and could be at a location which is remote from both.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A database arrangement for use with data items having one or more index terms associated therewith, comprising:
relationship storage means operable to store relationship information relating to the index terms associated with the data items in the database;
identifying means operable to identify the or each index term contained in a user request for interrogating the database;
consulting means operable to consult the relationship information to identify other index terms which are associated with data items with which the index terms or terms of the request are associated; and
information means operable to provide information relating to the index term or terms of the request and the other index terms, for presentation to a user.

2. An arrangement according to claim 2, wherein the information means provides information for presentation to a user in graphical form.

3. An arrangement according to claim 2, wherein the information is provided as a diagram of index terms, the diagram showing a link between combinations of index terms which are associated with data items in common.

4. An arrangement according to claim 3, wherein the links are provided to display weighting information representing the frequency of occurrence of at least some combinations.

5. An arrangement according to claim 4, wherein the frequency is the frequency of data items occurring in the database.

6. An arrangement according to claim 4, wherein the frequency is the frequency of new data items being added to the database.

7. An arrangement according to claim 1 wherein the arrangement is operable to receive requests from a user at a remote location.

8. An arrangement according to claim 7, wherein the arrangement is in communication with the user by means of a communication network.

9. An arrangement according to claim 8, wherein the communication network is a public or private network.

10. An arrangement according to claim 1 wherein the arrangement also comprises index means operable to identify the or each index term associated with a data item contained in or to be added to the database, and modifying means operable to modify the relationship information in accordance with the identified index terms.

11. An arrangement according to claim 10, wherein the modifying means are operable to modify the relationship information to record combinations of index terms which are associated with data items in common.

12. An arrangement according to claim 10, wherein the modifying means are operable to cause the relationship information to contain weighting information relating to at least some combinations, weightings being chosen according to a frequency of occurrence.

13. An arrangement according to claim 12, wherein the frequency is the frequency of occurrence of data items in the database.

14. An arrangement according to claim 12, wherein the frequency is the frequency of occurrence in new data items to be added to the database.

15. An arrangement according to claim 1 wherein the database arrangement is in communication with a database holding the data items, by means of a communication network.

16. An arrangement according to claim 15, wherein the communication network is a public or private network.

17. A signal propagating on a transmission medium, the signal representing information provided by information means of the database arrangement as set in claim 1, the information relating to the index term or terms of a request, and the other index terms, for presentation to a user.

18. A database arrangement for use with data items having one or more index terms associated therewith, comprising:
relationship storage means operable to store relationship information relating to the index terms associated with the data items in the database; and
index means operable to identify the or each index term associated with a data item contained in or to be added to the database,
the arrangement further comprising modifying means operable to modify the relationship information in accordance with the identified index terms.

19. An arrangement according to claim 18, wherein the modifying means are operable to modify the relationship information to record combinations of index terms which are associated with data items in common.

20. An arrangement according to claim 19, wherein the modifying means are operable to cause the relationship information to contain weighting information relating to at least some combinations, weighting being chosen according to a frequency of occurrence.

21. An arrangement according to claim 20, wherein the frequency is the frequency of occurrence in data items in the database.

22. An arrangement according to claim 20, wherein the frequency is the frequency of occurrence in new data items to be added to the database.

23. An arrangement according to claim 18, wherein the database arrangement is in communication with a database holding the data items, by means of a communication network.

24. An arrangement according to claim 23, wherein the communication network is a public or private network.

25. An arrangement according to claim 18, wherein the information means is operable to provide information for presentation to a user in graphical form.

26. An arrangement according to claim 25, wherein the information is provided as a diagram of index terms, the diagram showing a link between combinations of index terms which are associated with data items in common.

27. An arrangement according to claim 26, wherein the links are provided to display weighting information representing the frequency of occurrence of at least some combinations.

28. An arrangement according to claim 27, wherein the frequency is the frequency of data items occurring in the database.

29. An arrangement according to claim 27, wherein the frequency is the frequency of new data items being added to the database.

30. An arrangement according to claim 18, wherein the arrangement is operable to receive requests from a user at a remote location.

31. An arrangement according to claim 30, wherein the arrangement is in communication with the user by means of a communication network.

32. An arrangement according to claim 31, wherein the communication network is a public or private network.

33. A database arrangement for use with data items having one or more index terms associated therewith, comprising:
relationship storage means operable to store relationship information relating to the index terms associated with the data items in the database;
index means operable to identify the or each index term associated with a data item contained in or to be added to the database;
modifying means operable to modify the relationship information in accordance with the identified index terms;
identifying means operable to identify the or each index term contained in a user request for interrogating the database;
consulting means operable to consult the relationship information to identify other index terms which are associated with data items with which the index term or terms of the request are associated; and
information means operable to provide information relating to the index term or terms of the request and the other index terms, for presentation to a user.

34. An arrangement according to claim 33 further including a database containing the data items.

35. Computer software which, when installed on a computer system, is operable to provide a database arrangement defined in claim 1.

36. A carrier medium carrying computer software as defined in claim 35.

37. A method of providing a database for data items having one or more index terms associated therewith, in which:
relationship information is stored, relating to the index terms associated with the data items in the database;
the or each index term contained in a user request for interrogating the database is identified;
the relationship information is consulted to identify other index terms which are associated with data items with which the index terms of the request are associated; and
information relating to the index term or terms of the request and the other index terms is provided for presentation to a user.

38. A method according to claim 37, wherein the information is provided for presentation to a user in graphical form.

39. A method according to claim 38, wherein the information is provided as a diagram of index terms, the diagram showing a link between combinations of index terms which are associated with common data items.

40. A method according to claim 39, wherein the links are provided to display weighting information representing the frequency of occurrence of at least some combinations.

41. A method according to claim 40, wherein the frequency is the frequency of data items occurring in the database.

42. A method as claimed in claim 41, wherein the frequency is the frequency of new data items being added to the database.

43. A method according to claim 37, wherein requests from a user are received at a remote location.

44. A method according to claim 43, wherein communication with the user is by means of a communication network.

45. A method according to claim 44 wherein the communication network is a public or private network.

46. A method according to claim 37, wherein the or each index term associated with a data item contained in or to be added to the database is identified, and the relationship information is modified in accordance with the identified index terms.

47. A method according to claim 46, wherein combinations of index terms which are associated with data items in common are recorded.

48. A method according to claim 46 wherein the relationship information contains weighting information relating to at least some combinations, weightings being chosen according to a frequency or occurrence.

49. A method according to claim 48, wherein the frequency is the frequency of occurrence of data items in the database.

50. A method as claimed in claim 48, wherein the frequency is the frequency of occurrence in new data items to be added to the database.

51. A method of providing a database for data items having one or more index terms associated therewith, in which:
relationship information relating to the index terms associated with the data items is stored in the database;
the or each index term associated with a data item contained in or to be added to the database is identified; and
the relationship information is modified in accordance with the identified index terms.

52. A method according to claim 51, wherein the relationship is modified to record combinations of index terms which are associated with data items in common.

53. A method according to claim 52 wherein the relationship information contains weighting information relating to at least some combinations, weightings being chosen according to a frequency of occurrence, such as the frequency of occurrence in data items in the database, or the frequency of occurrence in new data items to be added to the database.

54. A method according to claim 52, wherein information is provided for presentation to a user in graphical form.

55. A method according to claim 54 wherein the information is provided as a diagram of index terms, the diagram showing a link between combinations of index terms which are associated with data items in common.

56. A method according to claim 55, wherein the links are provided to display weighting information representing the frequency of occurrence of at least some combinations.

57. A method according to claim 56, wherein the frequency is the frequency of data items occurring in the database.

58. A method according to claim 56, wherein the frequency is the frequency of new data items being added to the database.

59. A method according to claim 52, wherein requests from a user are received at a remote location.

60. A method according to claim 59, wherein communication with the user is by means of a communication network.

61. A method as claimed in claim 60, wherein communication is by a public or private network.

62. A method of providing a database for data items having one or more index terms associated therewith, in which:
relationship information relating to the index terms associated with the data items in the database is stored;
the or each index term associated with a data item contained in or to be added to the database is identified;
The relationship information is modified in accordance with the identified index terms;
the or each index term contained in a user request for interrogating the database is identified;
the relationship information is consulted to identify other index terms which are associated with data items with which the index term or terms of the request are associated; and
information relating to the index term or terms of the request and the other index terms is provided, for presentation to a user.

63-64. (canceled)
